(19) United States
(12) Patent Application Publication
(10) Pub. No.: US 2015/0081718 A1
(43) Pub. Date: Mar. 19, 2015

(54) IDENTIFICATION OF ENTITY INTERACTIONS IN BUSINESS RELEVANT DATA

(71) Applicant: Olaf Schmidt, Walldorf (DE)

(72) Inventor: Olaf Schmidt, Walldorf (DE)

(21) Appl. No.: 14/027,918

(22) Filed: Sep. 16, 2013

(51) Int. Cl. G06F 17/30

(52) U.S. Cl. CPC G06F 17/30657; G06F 17/30613; G06F 17/30424
USPC 707/741; 707/755

(57) ABSTRACT

The present disclosure describes methods, systems, and computer program products for extracting entity interaction information from business relevant data. One computer-implemented method includes receiving a dataset comprising information about a plurality of entities and comprising a plurality of non-overlapping data subsets, each of the data subsets having the same predetermined size, analyzing the dataset to identify a plurality of interactions in the dataset, each identified interaction associated with two or more entities from the plurality of entities, receiving a query regarding a specific interaction for a specific entity, determining whether one of the identified interactions for the specific entity matches the specific interaction, and providing information from one or more non-overlapping data subsets that each comprise data about the specific interaction and the specific entity based on determining that at least one of the identified interactions for the specific entity matches the specific interaction.

### BACKGROUND

Business relevant data can be transmitted through structured data (e.g., database) and/or unstructured data (e.g., free-text documents). Free text documents form the bulk of information transfer for business relevant data and the extraction of key business information from the free-text documents plays a major role in corporate information systems. Free-text documents may include, for example, purchase orders, contracts, memos, emails, web-based social media applications, content stored by online storage providers, and/or other documents. Key business information typically relates to interactions and relationships between defined entities (e.g., business partners, business documents, etc.) in certain business contexts. Examples of key business information include an employee relationship between a person and a company, a subsidiary relationship between two companies, or the information pertaining to which customer bought a certain product.

As the amount of structured and unstructured data is growing exponentially, it becomes more and more important to keep track, in real time, of the business relevant information hidden in the data. The integration of this kind of information with classical transaction business data and unstructured data in company content repositories can be a key aspect for decision making and business success. Without an ability to identify key business information and entity interactions, businesses are increasingly at a disadvantage in the competitive marketplace.

### SUMMARY

The present disclosure relates to computer-implemented methods, computer-readable media, and computer systems for extracting entity interaction information from business relevant data. One computer-implemented method includes receiving a first dataset comprising information about a first plurality of entities and comprising a plurality of non-overlapping first data subsets, each of the first data subsets having the same predetermined size, analyzing the first dataset to identify a plurality of first interactions in the first dataset, each identified first interaction associated with two or more entities from the first plurality of entities based on determining that information about the interaction and the two or more entities occurs in one of the non-overlapping first data subsets, receiving a query regarding a specific interaction for a specific entity, determining whether one of the identified first interactions for the specific entity matches the specific interaction, and providing information from one or more non-overlapping first data subsets that each comprise data about the specific interaction and the specific entity based on determining that at least one of the identified first interactions for the specific entity matches the specific interaction.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, further comprises storing, based on analyzing the first dataset to identify the plurality of first interactions in the first dataset, a first interaction index, the first interaction index comprising a record for each identified first interaction from the plurality of first interactions, the record comprising one or more words representing the interaction and one or more words for each of the two or more entities associated with the interaction.

A second aspect, combinable with any of the previous aspects, wherein the first interaction index comprises an unambiguous interaction index, storing the first interaction index comprises determining whether the words that represent the first interactions and words that represent the entities from the first plurality of entities are master terms in an alternate spelling index, and storing a corresponding master term in the unambiguous first interaction index for the words that are determined not to be master terms in the alternate spelling index, and determining whether one of the identified first interactions for the specific entity matches the specific interaction comprises determining whether the specific interaction and the specific entity are master term entries in the alternate spelling index, and determining whether one of the identified first interactions for the specific entity or a corresponding master term entry for the specific entity matches the specific interaction or a corresponding master term entry for the specific interaction.

A third aspect, combinable with the general implementation or any of the previous aspects, wherein the predetermined size comprises a sentence.

A fourth aspect, combinable with the general implementation or any of the previous aspects, further comprises receiving a second dataset comprising information about a second plurality of entities and comprising a plurality of non-overlapping second data subsets, each of the second data subsets having the same predetermined size as the first data subsets, and analyzing the second dataset according to a predetermined schedule identify a plurality of second interactions in the second dataset, each identified second interaction associated with two or more entities from the second plurality of entities based on determining that information about the interaction and the two or more entities occurs in one of the non-overlapping second data subsets.

A fifth aspect, combinable with the fourth aspect, wherein the second dataset comprises an update to the first dataset.

A sixth aspect, combinable with the fourth aspect, wherein the second dataset comprises data from a second source different than a first source for the first dataset, analyzing the second dataset comprises storing a second interaction index, the second interaction index comprising a record for each identified second interaction from the plurality of second interactions, the record comprising one or more words representing the interaction and one or more words for each of the two or more entities associated with the interaction, and receiving a query regarding a specific interaction for a specific entity comprises receiving an identification of the first dataset or the second dataset, the method further comprising determining whether one of the interactions for the identified dataset and for the specific entity match the specific interaction.

The subject matter described in this specification can be implemented in particular implementations so as to realize one or more of the following advantages. First, a system may identify interactions between two or more entities and create an interaction index using the identified interactions. Second, a system may respond to queries interaction data using an interaction index. Third, the system may analyze data and respond to queries in real time using in memory database technology. Fourth, a system may identify complex relationships between entities and respond to queries about the complex relationships. Fifth, a system may use different information extraction algorithms for data received from different data sources or for different types of data. Sixth, easily adaptable connectors can be leveraged to connect the system to various content repositories (e.g. relational databases, cloud-computing document stores, remote repositories, etc.) Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example environment for identifying interactions between multiple entities from business relevant data.

FIG. 2 is a swim lane diagram of an example method for updating an interaction index.

FIG. 3 is a swim lane diagram of an example method for responding to a query for entity interaction data.

FIG. 4 is a flow chart of a method for providing information about an interaction between two entities.

Like reference numbers and designations in the various drawings indicate like elements.

### DETAILED DESCRIPTION

This disclosure generally describes computer-implemented methods, computer-program products, and systems for identification of entity interactions. The following description is presented to enable any person skilled in the art to make and use the invention, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

Business relevant data can be transmitted through structured data (e.g., database) and/or unstructured data (e.g., free-text documents). Free text documents form the bulk of information transfer for business relevant data and the extraction of key business information from the free-text documents plays a major role in corporate information systems. Free-text documents may include, for example, purchase orders, contracts, memos, emails, web-based social media applications (e.g., FACEBOOK applications, XING, etc.), content stored by online storage providers (e.g. DROPBOX, GOOGLE DRIVE, etc.), and/or other documents. Key business information typically relates to interactions and relationships between defined entities (e.g., business partners, business documents, etc.) in certain business contexts. Examples of key business information include an employee relationship between a person and a company, a subsidiary relationship between two companies, or the information pertaining to which customer bought a certain product.

As the amount of structured and unstructured data is growing exponentially, it becomes more and more important to keep track, in real time, of the business relevant information hidden in the data. The integration of this kind of information with classical transaction business data and unstructured data in company content repositories can be a key aspect for decision making and business success. Without an ability to identify key business information and entity interactions, businesses are increasingly at a disadvantage in the competitive marketplace.

For the purposes of this disclosure, an “index” is a lookup-table built by indexing-systems (e.g., web-based search providers) and based on keywords identified in text documents or other data sources. The index provides a pointer to the corresponding positions in data sources where the keyword was identified. When a user wants to find information related to certain keywords these keywords are fed into a search-infrastructure which utilizes an index (or several indexes) in order to locate the information (e.g., text, records in database, web-page, etc.).

In order to provide sophisticated query mechanisms and fast query execution during daily business (e.g., a customer bought product X, etc.) or in the context of extensive discovery processes (e.g., which employee was in contact with customer B, documents produced by person X, etc.), appropriate information extraction and advanced information storage mechanisms are needed which support complex queries in regard to interactions and relationships between specified entities in various data-sources. Such complex queries cannot be executed based on a simple keyword index as previously described. Traditional indexes do not allow for the high-precision identification of interactions and relationships described in the available data-sources.

As an example, assume that a user is interested in all information related to a certain keyword ‘Entity1’. The search-infrastructure accesses the index and looks for the entry ‘Entitiy1’. The corresponding index-entry stores a list with pointers to relevant information in regard to the keyword. The corresponding links are returned to the user. In this case the result is quite accurate and the quality of the returned information is only related to the quality of the data in the attached data sources (e.g., text repositories, database tables, web-pages, etc.) rather than the quality of the index. However, the quality of the returned information changes as soon as the user is interested in other types of information based on specific interactions/relationships of certain entities (e.g., ‘Entity1 interacts with Entity2’ or ‘Entity1 is related to Entity2’). In these examples ‘interacts’ could be substituted by any verb (e.g., sells, buys, communicates, etc.) and ‘is related’ could specify any type of relationship. When using the keyword-based index, the search infrastructure would split the query into sub-queries for ‘Entity1’, ‘Entity2’ and ‘interaction’ and merge the corresponding result-lists by Boolean operations (e.g., “AND” or “OR”). The final result is a list of links to information which deals with all specified keywords (e.g., text documents which contain all keywords). This approach produces rather inaccurate results which don't necessarily reflect the intended specific interactions. The result-list could include links to text-documents which contain all keywords in different sentences but where the originally specified interaction is not explicitly mentioned and can be observed when using search-engines for the World Wide Web in order to identify web-pages dealing with a certain interaction between specified entities.

By utilizing sophisticated methods of information extraction (e.g., natural language processing for unstructured data), the quality of the results for such complex interaction based queries can significantly be improved. This disclosure describes an on-demand information extraction framework that utilizes these algorithms/methods to provide the information extraction functionality as well as the corresponding query infrastructure as cloud-computing based service. The described cloud-based computing framework supports the accurate discovery of interactions and relationships between entities described in both structured and unstructured data. Decision processes are supported by providing mechanisms to analyze relationship information in real-time using high-performance database technologies. For example, in some implementations, due to the efficient utilized column store and high-speed performance of in-memory database technology, one or more in-memory-type databases are leveraged for database support. In other implementations, enhanced and/or optimized traditional databases can be used, possibly in conjunction with in-memory databases.

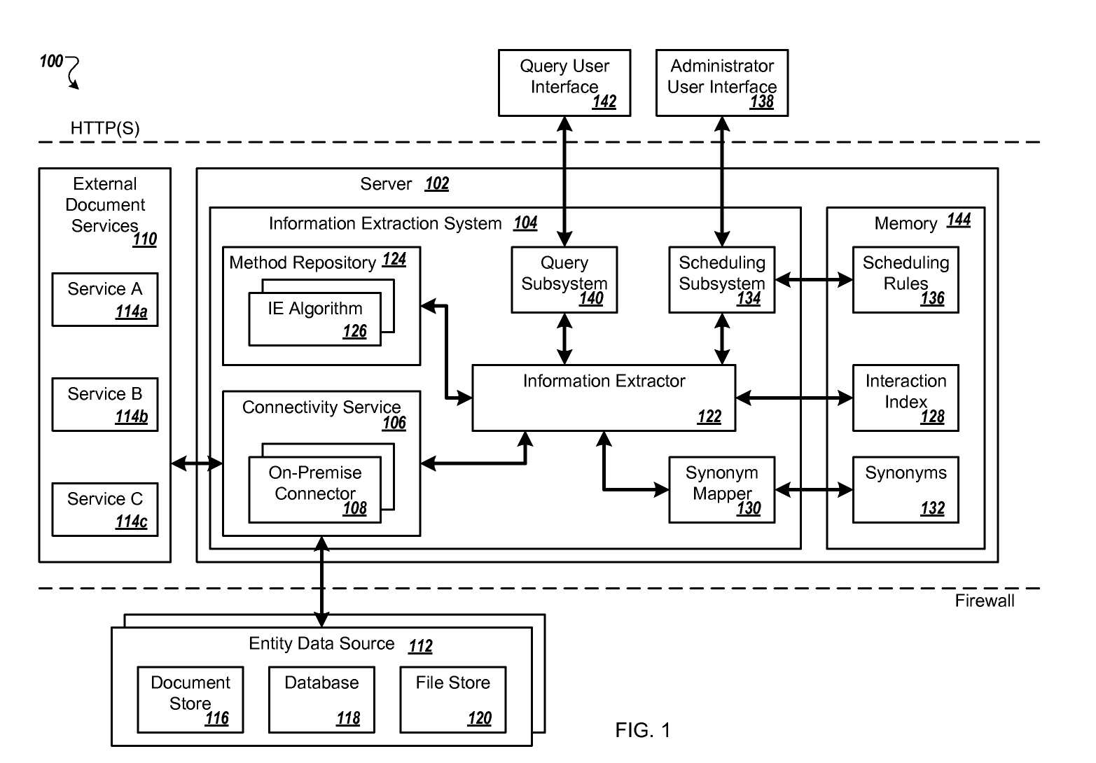

FIG. 1 is a block diagram illustrating an example environment 100 for identifying interactions between multiple entities from business relevant data. For example, the environment 100 includes a server 102 with an information extraction system 104. In some implementations, the server 102 can execute in a cloud-computing based environment.

In general, the information extraction system 104 receives business relevant data in a dataset from multiple different sources and identifies interactions and entities associated with the interactions in the data using an information extractor 122. For example, in the identified interactions and entities, verbs can represent the interactions and nouns the entities. In some implementations, the information extraction system 104 can determine subsets of the received dataset, and identify entity interactions within the subsets, where each of the identified interactions occurs in a subset that includes data about the interaction and two or more entities. Examples of interactions may include a purchase, a sale, a licensing agreement, a joint development agreement, and other types of business agreements. For example, a first entity may agree to work with a second entity on research and development in a particular field. In some examples, a third entity may sell one or more products to a fourth entity.

In some implementations, each of the subsets can be a predetermined size. For example, when each of the subsets is a sentence, the information extraction system can identify the separate sentences in a received dataset, and determine whether each of the sentences includes data about an interaction and two or more entities.

In some implementations, the information extraction system 104 can include an API. The API can provide for the integration of new information extraction (IE) algorithms 126, integration of language tools such as a thesaurus, additional synonyms 132, scheduling rules 136, and/or other suitable tools, rules, data, etc.

As business information is typically stored in different data-source repository types and in different locations (e.g., external document services 110, entity data sources 112, etc.), easily adaptable connectors 108 to the various content repositories are available. Each external document services 110 may include services (e.g., Service A, Service B, and Service C) that can provide documents to the information extraction system. The services 114a-c may include websites, e.g., that include news articles, and network repositories, e.g., online data storage, file transfer protocol servers, and/or other document services consistent with this disclosure. Each entity data source 112 may include a document store 116, database 118, file store 120, and/or other data sources consistent with this disclosure.

The information extraction system 104 includes a connectivity service 106 (described in more detail below) that receives data from the different data sources using one or more connectors 108. For example, the connectivity service 106 includes an on-premise connector 108 for each of the different data sources, such as external document services 110 and entity data sources 112. The on-premise connector associated with the entity data source 112 provides an interface between the information extraction system 104 and the entity data source 112, including methods for accessing, retrieving, and/or storing documents with the external document services 10 and/or entity data source 112. Although the on-premise connector 108 is illustrated as integral to the connectivity service, in some implementations, the on-premise connector may be associated with a particular external document service 110 and/or entity data source 112 with the connectivity service 106 connecting directly to the “remote” on-premise connector 108. In other implementations, the on-premise connector 108 can be split into portions associated with the information extraction system 104 and the external document service 110 and/or entity data source 112.

In some implementations, when the external document services 110 includes multiple services 114a-c, such as Service A, Service B, and Service C, the connectivity service 106 includes one or more on-premise connector 108 for each of the services 114a-c. For example, the connectivity service 106 includes a Service A on-premise connector, a Service B on-premise connector, and a Service C on-premise connector. In other implementations, the connectivity service 106 can use a single on-premise connector 108 to connect to the multiple services. Similarly, the connectivity service 106 can also include one or more on-premise connectors 108 for each entity data source 112. For example, the connectivity service 106 may include a document store on-premise connector, an entity database on-premise connector, and a file store on-premise connector.

The connectivity service 106 provides the data received from the external document services 110 and the entity data sources 112 to an information extractor 122. The information extractor 122 accesses a method repository 124 to select one of a plurality of IE algorithms 126. The information extractor 122 may select one or more IE algorithms 126 based on the source, type, format, context, etc. of the received data. For example, one or more of the data sources, such as the external document services 110 and the entity data sources 112, may correspond with a particular IE algorithm 126 based on the type and/or format of data the data source provides the connectivity service 106.

The information extractor 122 uses the selected IE algorithm 126 to identify non-overlapping data subsets in the dataset received from the connectivity service 106. For example, the information extractor 122 identifies the sentences or paragraphs included in the dataset, e.g., based on the parameters of the selected IE algorithm 126, and creates a subset for each of the identified sentences or paragraphs.

The information extractor 122 uses the selected IE algorithm 126 to generate an interaction index 128 that stores interactions identified by the information extractor 122 and the entities associated with the interactions. For example, the information extractor 122 may use a particular IE algorithm 126 to identify interactions in the data subsets from the document store 116 and entities that correspond with the interactions, and store the identified interactions and corresponding entities in the interaction index 128. In some examples, the information extractor 122 stores a record for each interaction where the record includes data that represents the interaction, e.g., the verb for the interaction, and data representing the two or more entities that participated in the interaction, e.g., the nouns for the two or more entities. The data that represents the interaction and the entities for a single record is extracted from the same data subset.

In some implementations, the interaction index 128 is based on a controlled vocabulary, meaning that a thesaurus and/or synonym lookup are used in order to build an unambiguous interaction index 128 and to perform queries on the interaction index 128. For example, an exemplary interaction index 128 may include: “Interaction; Entity1, Entity 2; List of references to relevant data stored in connected data sources.” Note that the entries (e.g., Interaction, Entity1 and Entity2) can be transformed according to a controlled vocabulary. This means that it makes no difference whether full names or acronyms are used for the entities or if different tenses (past, present, future, etc.) are used for the interaction-verb. Here, it is possible to build domain-specific indexes due to the fact that words have different meanings in different domains. The interaction index 128 can also deal with synonyms, taxonomies, and/or different time forms of interaction verbs. The interaction index 128 can also be separated for different domains (→load balancing; index sizes→faster lookup). Synonyms can also be used for verbs and for objects (e.g., Microsoft—MS—identification number for stocks, etc.).

In some implementations, the information extractor 122 uses a synonym mapper 130 or another term mapper, e.g., a thesaurus mapper, to identify terms with similar meanings. For example, the information extractor 122 may provide the synonym mapper 130 with a word to determine whether the word is on a master list of terms and reduce the quantity of different terms stored in the interaction index 128. The synonym mapper 130 accesses a list of synonyms 132 to determine a master synonym for the received word, if the received word is not a master synonym, and provides the master synonym to the information extractor 122. The information extractor 122 then stores the master synonym in the interaction index 128 allowing the information extractor 122 to identify key terms when generating the interaction index 128 and reduce the number of terms used when later querying the interaction index 128.

For example, when the synonyms 132 includes the terms “sell,” “vend,” “deal,” and “trade” as synonyms with “sell” as the master synonym for the terms, the information extractor 122 would store the term “sell” in the interaction index 128 anytime the information extractor 122 identifies “sell,” “vend,” “deal,” or “trade” as an interaction. Similarly, the information extractor 122 would use the term “sell” whenever identifying data responsive to a query that includes any of the terms “sell,” “vend,” “deal,” or “trade.”

The information extractor 122 may receive information from a scheduling subsystem 134 indicating when the information extractor 122 should analyze data. For example, the scheduling subsystem 134 may activate the information extractor 122 according to scheduling rules 136 that indicate when the scheduling subsystem 134 should analyze data from one or more of the data sources (e.g., fixed points in time or on a regular basis (every night, once a week, etc.)). In some implementations, the scheduling sub-system 134 can start the extraction processes automatically and the extraction results are inserted into the interaction/relationship storage (e.g., the interaction index 128, etc.). The scheduling rules 136 may include different rules for each of the data sources. For example, the scheduling rules 136 may include a first rule indicating that the information extractor 122 should analyze data from the Service A 114a every month and data from the file store 120 for a particular entity every other month.

The scheduling rules 136 may indicate that the information extractor 122 should request data from the respective data source prior to analyzing the data from the data source. In some examples, the scheduling rules 136 may indicate that the information extractor 122 should request data for the respective data source from a database, such as a database included in the server 102 or another computer that previously received data from the respective data source.

In some implementations, an operator accesses an administrator user interface 138 to request analysis of data by the information extractor 122 or to adjust one or more of the scheduling rules 136. For example, the administrator user interface 138 may provide information to the scheduling subsystem 134 indicating that the information extractor 122 should analyze data or indicating an update to one of the scheduling rules 136.

In some implementations, the scheduling rules 136 include rules that indicate the information extractor 122 should analyze received data during off peak hours. For example, the environment 100 may determine, based on analysis or operator input, off peak hours for the different data sources where the off peak hours may vary for each of the data sources.

A query subsystem 140 provides the information extractor 122 with interaction requests. For example, a user of a query user interface 142 may enter a query in the query user interface 142 that requests data about a particular entity or a particular interaction of a particular entity. The query user interface 142 provides the query to the query subsystem 140 and the query subsystem 140 forwards the query to the information extractor 122, receives a response from the information extractor 122, and provides the response to the query user interface 142.

In some examples, the query subsystem 140 receives queries from other components or systems. For example, a system that provides automated reports about entities may send a query for a particular entity or particular interaction of a particular query to the query subsystem 140 and include response data received from the query subsystem 140 in a report.

In some implementations, the query subsystem 140 can read query-parameters and perform a search based on the interaction index 128. Input parameters can be transformed using controlled vocabulary before the interaction index 128 is accessed. Based on analysis of the input parameters by the query subsystem 140, different data sources can be accessed for a received query. Domains of interest can also be specified in a received query or automatically detected based on interaction verbs and interaction partners (e.g., if interaction partners are corporations, only particular interaction indexes 128 are relevant).

In some implementations, a memory 144 stores the interaction index 128, the synonyms 132, and/or the scheduling rules 136. For example, the memory 144 is a low latency memory, such as a random access memory or a solid state drive, that provides the information extraction system 104 with fast access to data. In some examples, the memory 144 stores the interaction index 128 in a database.

In some implementations, the memory 144 includes a separate interaction index for each data source or each entity. For example, the memory 144 may include a first interaction index for the Service A, a second interaction index for the Service B, and a third interaction index for a first entity.

In some implementations, the connectivity service 106 can include an application programming interface (API) for the on-premise connectors 108. For example, the connectivity service API can allow the information extraction system 104 to easily receive data from a new data source by including a new on-premise connector 108 in the connectivity service 106, where the new on-premise connector is for the new data source.

In some implementations, the method repository 124 includes an API for the IE algorithms 126. For example, the information extraction system 104 receives data from a new source, or a new format of data from a new or existing source, the method repository API may allow the information extraction system 104 to easily receive new extraction algorithms for the new format of data.

In some implementations, the information extraction system 104 includes an extensible parser that identifies a format of the received data, e.g., a document file format, selects a parser implementation specific to the format, and provides the parser implementation to the information extractor 122. For example, the information extractor 122 uses the parser implementation to access the data in the received data and uses the information extraction algorithm 126 to analyze the parsed data and identify interactions and entities. In some examples, the information extractor 122 uses the parser implementation to identify the non-overlapping data subsets in the received data and, after identifying the non-overlapping data subsets, uses the information extraction algorithm 126 to analyze the non-overlapping data subsets and identify interactions and entities.

For example, the connectivity service 106 may receive unstructured data in a variety of file formats and the information extraction system 104 may use the extensible parser and the parser implementations to extract data from the different types of files. The parser implementations may then extract data from the received data and provide the extracted data to the information extractor 122 in a format that the information extractor 122 may analyze.

In some implementations, the connectivity service 106 includes the extensible parser and provides the information extractor 122 extracted data upon request. In some implementations, the information extractor 122 includes the extensible parser. For example, the information extractor 122 may receive unstructured data from the connectivity service 106, provide information about the unstructured data to the extensible parser, e.g., the file format of the unstructured data, receive a parser implementation from the extensible parser, and extract data from the received data using the parser implementation. In some implementations, the method repository 124 includes the parser implementations and/or the extensible parser.

The extensible parser allows the information extraction system 104 to receive new types of data, such as new file formats or new data layouts. For example, the extensible parser may include an API that supports a different parser implementation for each supported file type and when the system receives unstructured data that has a file type currently unsupported by the information extraction system 104, the information extraction system 104 may receive a new parser implementation specific to the currently unsupported file type, e.g., from a repository of parser implementations or created by a developer.

In some implementations, the information extractor 122 extracts images or information associated with images from the received data. For example, a parser implementation may identify an image description using the properties of the image and provide the image description to the information extractor 122. The information extractor 122 may use an information extraction algorithm 126 to analyze the image description and determine whether the image description includes an interaction associated with two or more entities. For example, when the information extractor 122 identifies an interaction associated with two or more entities in the image description, the information extractor 122 creates a record in the interaction index 128, or updates an existing record, for the identified interaction and entities.

In some implementations, when the information extractor 122 identifies an interaction associated with two or more entities in an image description and the information extractor 122 receives a request for which the identified interaction is responsive, the information extractor 122 may provide information about the image to the query subsystem 140. For example, the information extractor 122 may provide a copy of the image to the query subsystem 140 such that the query user interface 142 will present the copy of the image to a user.

In some implementations, the server 102 and the entity data sources 112 communicate across one or more of firewalls. For example, one or more of the entity data sources 112 may include a firewall such that the corresponding on-premise connectors 108 communicate with the firewalled entity data sources 112 across the firewall. The on-premise connectors 108 may include credentials that the on-premise connectors 108 use to access data that is behind a firewall.

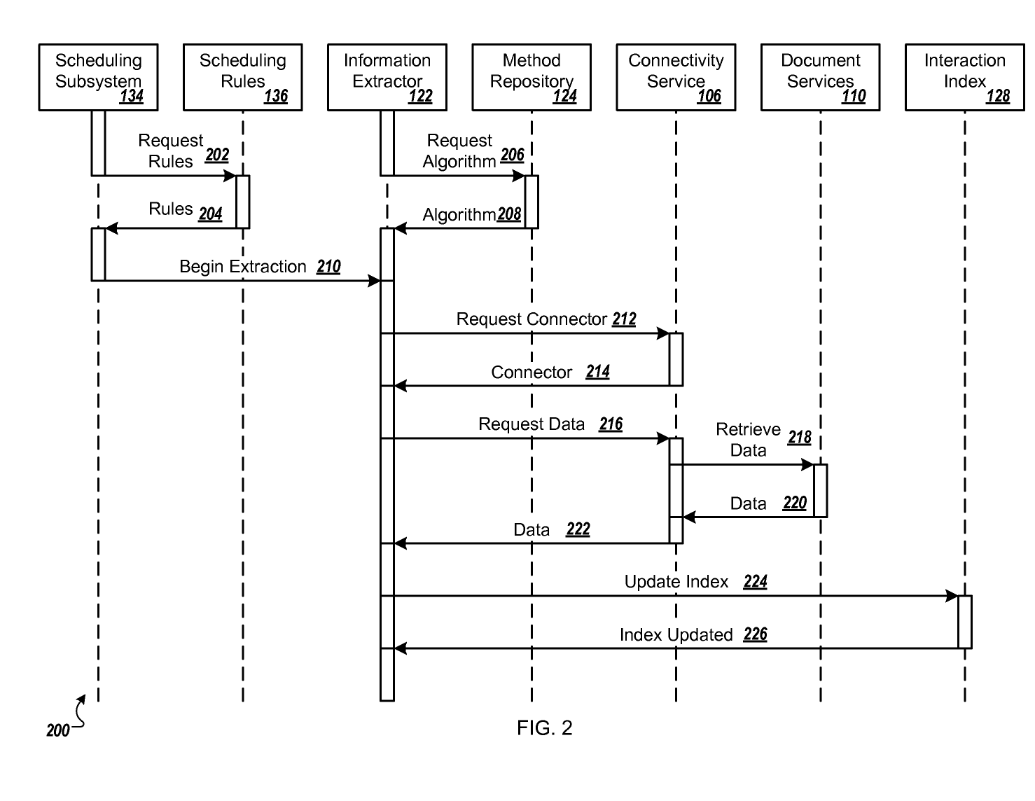

FIG. 2 is a swim lane diagram of an example method 200 for updating an interaction index. For example, the method 200 can be performed by one or more components from the information extraction system 104 shown in FIG. 1. However, it will be understood that the method 200 may be performed, for example, by any other suitable system, environment, software, and hardware, or a combination of two or more of those. In some implementations, various steps of the method 200 can be run in parallel, in combination, in loops, or in any order.

The scheduling subsystem 134 requests 202 rules from the scheduling rules 136 and receives 204 the rules. For example, the scheduling subsystem 134 identifies a subset of the rules stored in the scheduling rules 136 and requests the identified rules. The rules indicate when the information extractor 122 should analyze data received from one or more data sources.

The information extractor 122 requests 206 an IE algorithm 126 from the method repository 124 and receives 208 the requested IE algorithm. For example, the information extractor 122 may request a particular algorithm from the method repository 124 or request an algorithm that applies to a particular data source or type of data that the information extractor 122 will analyze.

In some implementations, the information extractor 122 requests the algorithm from the method repository 124 in response to data received from the scheduling subsystem 134. For example, the scheduling subsystem 134 may determine that the information extractor 122 should analyze data from a particular data source, send a message to the information extractor 122 about the data that should be analyzed, and the information extractor 122 requests an IE algorithm 126 from the method repository 124 where the requested extraction algorithm is for the data that should be analyzed.

The scheduling subsystem 134 sends 210 a message to the information extractor 122 indicating that the information extractor 122 should begin extraction of interactions and corresponding entities from received data. In some examples, the message that indicates that the information extractor 122 should begin extraction includes information about the data that should be analyzed, e.g., and the information extractor 122 requests an IE algorithm 126 in response to receiving the message from the scheduling subsystem 134.

The information extractor 122 requests 212 a connector from the connectivity service 106 for the data that should be analyzed. For example, the connectivity service 106 provides 214 the information extractor 122 with a link to the on-premise connector associated with the data that should be analyzed.

The information extractor 122 requests 216 data from the connectivity service 106. For example, the information extractor 122 uses the on-premise connector to request the data that should be analyzed from the connectivity service 106 and the connectivity service 106 retrieves 218 data from the external document services 110 based on the on-premise connector. The information extractor 122 may identify a specific portion of data from the external document services 110 for analysis or may request any available data from the external document services 110.

In some implementations, the connectivity service 106 may request data from the external document services 110 and other data sources in response to receiving the request 212 from the information extractor 122.

In some implementations, the information extractor 122 analyzes all data available from a particular data source. In some implementations, the information extractor 122 requests and analyzes a portion of data available from a particular data source, such as the data that was added to the data source since the last time the information extractor 122 received data from the data source.

The connectivity service 106 receives 220 the requested data from the external document services 110 and provides 222 the data to the information extractor 122. The information extractor 122 analyzes the received data to identify interactions that correspond with two or more entities and updates 224 the interaction index 128. In some implementations, the information extractor 122 receives 226 a confirmation that the interaction index 128 was updated.

In some implementations, the information extractor 122 verifies that the interaction index 128 does not include a record for an identified interaction and corresponding entities prior to updating the interaction index 128. For example, the information extractor 122 verifies that the identified interaction and entity combination is new so that the interaction index 128 does not include duplicate records.

In these implementations, the information extractor 122 may update the interaction index 128 with the new data. For example, each record in the interaction index 128 may include a reference to the data source from which the record was generated. When the interaction index 128 creates a new record for an interaction and two or more entities, the record includes data that identifies the data source that included the interaction and the entity names in a data subset, e.g., in a sentence or paragraph. When the interaction index 128 determines that reference to the same interaction and entities is included in another data subset, the interaction index 128 updates the record to include reference to the other data subset in addition to the data subsets already identified in the record.

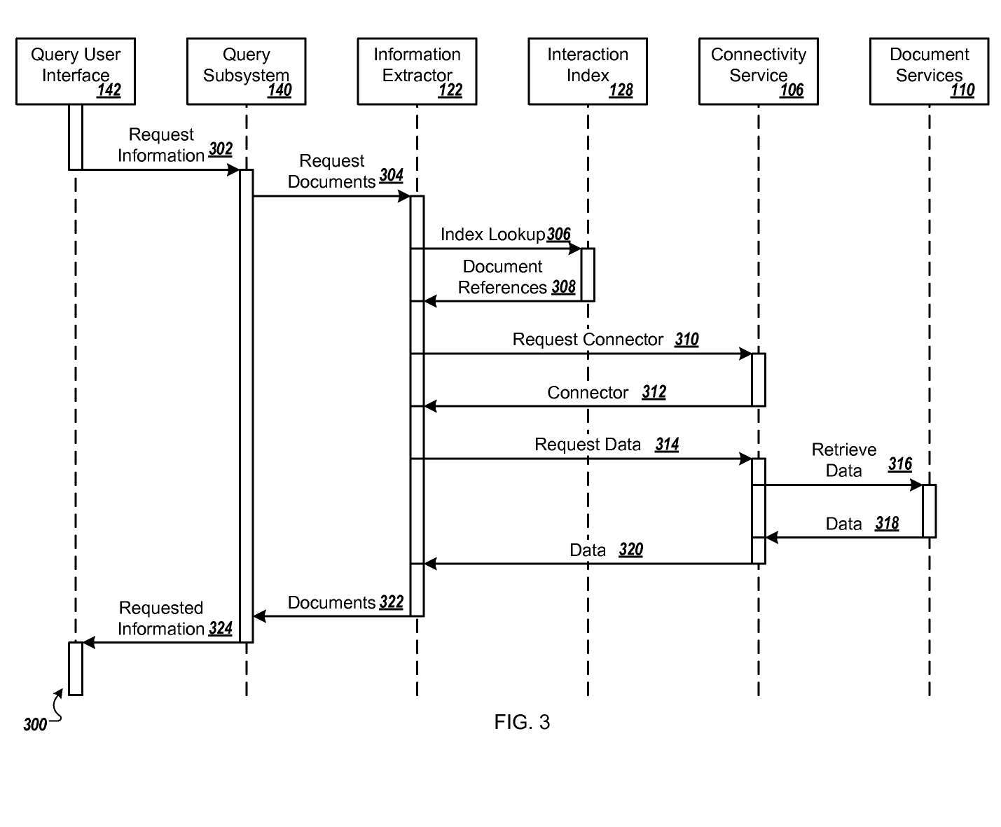

FIG. 3 is a swim lane diagram of an example method 300 for responding to a query for entity interaction data. For example, the method 300 can be performed by one or more components from the information extraction system 104 shown in FIG. 1. However, it will be understood that the method 300 may be performed, for example, by any other suitable system, environment, software, and hardware, or a combination of two or more of those. In some implementations, various steps of the method 300 can be run in parallel, in combination, in loops, or in any order.

The query subsystem 140 receives 302 a request for information from the query user interface 142. For example, the query user interface 142 receives input indicating operator identification of a query regarding a specific entity and an interaction for the specific entity. In some examples, the query identifies one or more entities, e.g., and may or may not identify an interaction.

The query subsystem 140 requests 304 documents responsive to the request for information from the information extractor 122. For example, the query subsystem 140 parses the request for information, identifies the specific entity and the interaction, and sends a request to the information extractor 122 that includes data identifying the specific entity and the interaction.

The information extractor 122 accesses the interaction index 128 and performs 306 an index lookup using the specific entity and the interaction. For example, the information extractor 122 uses any appropriate algorithm to identify one or more records in the interaction index 128 that include the name of the specific entity and the name of the interaction. In some implementations, the information extractor 122 identifies records in the interaction index 128 that include alternate spellings for the specific entity name, the interaction name, or both.

The information extractor 122 receives 308 document references from the interaction index 128. For example, each of the identified records includes one or more references to documents or other data that indicate the data sources used to generate the record.

The information extractor 122 uses the references to request 310 connectors from the connectivity service 106. For example, the information extractor 122 provides the references to the connectivity service 106 and receives 312 connectors from the connectivity service 106 that identify specific data, included in the data sources, that is responsive to the request for information.

The information extractor 122 uses the connectors to request 314 data from the connectivity service 106 and the connectivity service 106 uses the connectors to retrieve 316 the requested data from the external document services 110 and other data sources. In some implementations, when the information extractor 122 provides the references to the connectivity service 106, the connectivity service retrieves the data from the external document services 110 without providing connectors to the information extractor 122.

The connectivity service 106 receives 318 the requested data from the external document services 110 and the other data sources and provides 320 the requested data to the information extractor 122.

The information extractor 122 provides 322 the requested data to the query subsystem 140, and the requested information is sent 324 to the query user interface 142. For example, the information extractor 122 formats the requested data in one or more documents and provides the documents to the query subsystem 140 in response to the document request.

In some implementations, the information extractor 122 provides the references from the interaction index 128 or the connectors from the connectivity service 106 in response to the document request. For example, when the references or connectors include uniform resource identifiers, the information extractor 122 may provide a uniform resource identifier to the query subsystem 140 in response to the document request.

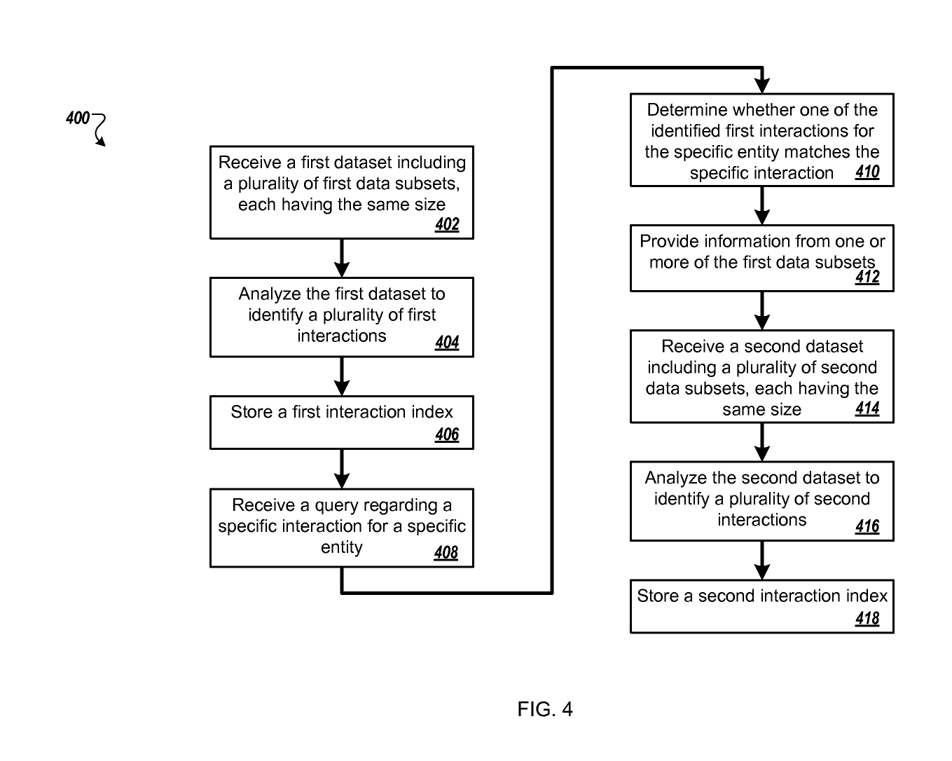

FIG. 4 is a flow chart of a method 400 for providing information about an interaction between two entities. For example, the method 400 can be performed by the information extraction system 104 from the environment 100 shown in FIG. 1. However, it will be understood that method 400 may be performed, for example, by any other suitable system, environment, software, and hardware, or a combination of systems, environments, software, and hardware as appropriate. In some implementations, various steps of method 400 can be run in parallel, in combination, in loops, or in any order.

At 402, the information extraction system receives a first dataset including a plurality of first data subsets, each of the first data subsets having the same size. The first dataset includes information about a first plurality of entities. Each of the first data subsets is non-overlapping with the other first data subsets. For example, each of the first data subsets is a sentence of the first dataset. In some examples, each of the first data subsets is a paragraph of the first dataset. The size of the first data subsets may be selected so that the information extraction system has a high probability of identifying entities that are related by the interaction.

In some examples, the connectivity service receives the first dataset from one of the data sources, such as the Service A, an entity data source, or a document store. In some examples, the connectivity service receives data for the first dataset from multiple different data sources.

At 404, the information extraction system analyzes the first dataset to identify a plurality of first interactions. Each of the identified first interactions is associated with two or more entities from the first plurality of entities based on determining that information about the interaction and the two or more entities occurs in one of the non-overlapping first data subsets.

At 406, the information extraction system stores a first interaction index. The first interaction index includes a record for each identified first interaction from the plurality of first interactions where the record includes one or more words representing the interaction and one or more words for each of the two or more entities associated with the interaction. The first interaction index is stored based on the analysis of the first dataset to identify the plurality of first interactions in the first dataset.

In some implementations, the first interaction index comprises an unambiguous interaction index. For example, the information extraction system determines whether the words that represent the first interactions and words that represent the entities from the first plurality of entities are master terms in an alternate spelling index. In some examples, the information extraction system uses the alternate spelling index to identify synonyms, abbreviations, alternate spellings, acronyms, expansions, and different grammatical numbers of the master terms using the alternate spelling index and stores a corresponding master term in the unambiguous first interaction index for the words that are determined not to be master terms in the alternate spelling index.

At 408, the information extraction system receives a query regarding a specific interaction for a specific entity. For example, the query subsystem receives the query from the query user interface and forwards the query to the information extractor. In some implementations, the query subsystem parses a query received from the query user interface, formats data from the received query, and provides the formatted data to the information extractor.

At 410, the information extraction system determines whether one of the identified first interactions for the specific entity matches the specific interaction. For example, the information extraction system accesses the interaction index to determine whether one or more records in the interaction index contain data responsive to the received query.

In some implementations, when the information extraction system uses an unambiguous interaction index, the information extraction system determines whether the specific interaction and the specific entity are master term entries in the alternate spelling index and determines whether one of the identified first interactions for the specific entity or a corresponding master term entry for the specific entity matches the specific interaction or a corresponding master term entry for the specific interaction.

At 412, the information extraction system provides information from one or more of the first data subsets based on determining that one of the identified first interactions for the specific entity matches the specific interaction. The one or more of the first data subsets each include data about the specific interaction and the specific entity. For example, the information extraction system provides a uniform resource locator to the query user interface where the uniform resource locator identifies the location of data responsive to the received query. In some examples, the information extraction system identifies the data subsets used to create the records from the interaction index that contain data responsive to the received query and provides the data subsets, e.g., in one or more formatted documents, to the query user interface.

At 414, the information extraction system receives a second dataset including a plurality of second data subsets, each of the second data subsets having the same size. The second dataset includes information about a second plurality of entities. In some examples, an entity is included in both the first plurality of entities and the second plurality of entities. In some examples, the first plurality of entities and the second plurality of entities are disjoint sets.

Each of the second data subsets is non-overlapping with the other second data subsets. In some examples, the size of the second data subsets is the same as the size of the first data subsets.

In some implementations, the second dataset includes an update to the first dataset. For example, the second dataset includes data that was also included in the first dataset, such as a webpage, and also includes an update to some of the data from the first dataset, such as a new version of a webpage that was included in the first dataset.

At 416, the information extraction system analyzes the second dataset to identify a plurality of second interactions. Each identified second interactions is associated with two or more entities from the second plurality of entities based on determining that information about the interaction and the two or more entities occurs in one of the non-overlapping second data subsets.

At 418, the information extraction system stores a second interaction index. For example, the information extraction system may store the second interaction index in memory and remove the first interaction index from memory, e.g., the second interaction index may overwrite the first interaction index.

In some implementations, the information extraction system stores the second interaction index without erasing the first interaction index. For example, when the second interaction index was generated from a data received from different data sources than the first interaction index, the information extraction system may store the second interaction index in the same memory as the first interaction index.

In some implementations, the method 400 can include additional steps, fewer steps, or some of the steps can be divided into multiple steps. For example, the second dataset may include data from a second source different than a first source for the first dataset. The information extraction system may analyze the second dataset and store a second interaction index where the second interaction index includes a record for each identified second interaction from the plurality of second interactions. Each record may include one or more words representing the interaction and one or more words for each of the two or more entities associated with the interaction.

The information extraction system may receive a query regarding a specific interaction for a specific entity where the query includes an identification of the first dataset or the second dataset, e.g., where the information extraction system will search the interaction index associated with the identified dataset for data responsive to the query. The information extraction system may then determine whether one of the interactions for the identified dataset and for the specific entity match the specific interaction and provide data responsive to the received query to the query user interface.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a graphics processing unit (GPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a GPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method comprising:
receiving a first dataset comprising information about a first plurality of entities and comprising a plurality of non-overlapping first data subsets, each of the first data subsets having the same predetermined size;
analyzing the first dataset to identify a plurality of first interactions in the first dataset, each identified first interaction associated with two or more entities from the first plurality of entities based on determining that information about the interaction and the two or more entities occurs in one of the non-overlapping first data subsets;
receiving a query regarding a specific interaction for a specific entity;
determining whether one of the identified first interactions for the specific entity matches the specific interaction; and
providing information from one or more non-overlapping first data subsets that each comprise data about the specific interaction and the specific entity based on determining that at least one of the identified first interactions for the specific entity matches the specific interaction.

2. The method of claim 1, further comprising storing, based on analyzing the first dataset to identify the plurality of first interactions in the first dataset, a first interaction index, the first interaction index comprising a record for each identified first interaction from the plurality of first interactions, the record comprising one or more words representing the interaction and one or more words for each of the two or more entities associated with the interaction.

3. The method of claim 2, wherein:
the first interaction index comprises an unambiguous interaction index;
storing the first interaction index comprises:
determining whether the words that represent the first interactions and words that represent the entities from the first plurality of entities are master terms in an alternate spelling index; and
storing a corresponding master term in the unambiguous first interaction index for the words that are determined not to be master terms in the alternate spelling index; and
determining whether one of the identified first interactions for the specific entity matches the specific interaction comprises:
determining whether the specific interaction and the specific entity are master term entries in the alternate spelling index; and
determining whether one of the identified first interactions for the specific entity or a corresponding master term entry for the specific entity matches the specific interaction or a corresponding master term entry for the specific interaction.

4. The method of claim 1, wherein the predetermined size comprises a sentence.

5. The method of claim 1, further comprising:
receiving a second dataset comprising information about a second plurality of entities and comprising a plurality of non-overlapping second data subsets, each of the second data subsets having the same predetermined size as the first data subsets; and
analyzing the second dataset according to a predetermined schedule identify a plurality of second interactions in the second dataset, each identified second interaction associated with two or more entities from the second plurality of entities based on determining that information about the interaction and the two or more entities occurs in one of the non-overlapping second data subsets.

6. The method of claim 5, wherein the second dataset comprises an update to the first dataset.

7. The method of claim 5, wherein:
the second dataset comprises data from a second source different than a first source for the first dataset;
analyzing the second dataset comprises storing a second interaction index, the second interaction index comprising a record for each identified second interaction from the plurality of second interactions, the record comprising one or more words representing the interaction and one or more words for each of the two or more entities associated with the interaction; and
receiving a query regarding a specific interaction for a specific entity comprises receiving an identification of the first dataset or the second dataset;
the method further comprising determining whether one of the interactions for the identified dataset and for the specific entity match the specific interaction.

8. A non-transitory, computer-readable medium storing computer-readable instructions executable by a computer and operable to:
receive a first dataset comprising information about a first plurality of entities and comprising a plurality of non-overlapping first data subsets, each of the first data subsets having the same predetermined size;
analyze the first dataset to identify a plurality of first interactions in the first dataset, each identified first interaction associated with two or more entities from the first plurality of entities based on determining that information about the interaction and the two or more entities occurs in one of the non-overlapping first data subsets;
receive a query regarding a specific interaction for a specific entity;
determine whether one of the identified first interactions for the specific entity matches the specific interaction; and
provide information from one or more non-overlapping first data subsets that each comprise data about the specific interaction and the specific entity based on determining that at least one of the identified first interactions for the specific entity matches the specific interaction.

9. The computer-readable medium of claim 8, further operable to store, based on analyzing the first dataset to identify the plurality of first interactions in the first dataset, a first interaction index, the first interaction index comprising a record for each identified first interaction from the plurality of first interactions, the record comprising one or more words representing the interaction and one or more words for each of the two or more entities associated with the interaction.

10. The computer-readable medium of claim 9, wherein:
the first interaction index comprises an unambiguous interaction index;
the instructions operable to store the first interaction index comprise instructions operable to:
determine whether the words that represent the first interactions and words that represent the entities from the first plurality of entities are master terms in an alternate spelling index; and
store a corresponding master term in the unambiguous first interaction index for the words that are determined not to be master terms in the alternate spelling index; and
the instructions operable to determine whether one of the identified first interactions for the specific entity matches the specific interaction comprise instructions operable to:
determine whether the specific interaction and the specific entity are master term entries in the alternate spelling index; and
determine whether one of the identified first interactions for the specific entity or a corresponding master term entry for the specific entity matches the specific interaction or a corresponding master term entry for the specific interaction.

11. The computer-readable medium of claim 8, wherein the predetermined size comprises a sentence.

12. The computer-readable medium of claim 8, further operable to:
receive a second dataset comprising information about a second plurality of entities and comprising a plurality of non-overlapping second data subsets, each of the second data subsets having the same predetermined size as the first data subsets; and
analyze the second dataset according to a predetermined schedule identify a plurality of second interactions in the second dataset, each identified second interaction associated with two or more entities from the second plurality of entities based on determining that information about the interaction and the two or more entities occurs in one of the non-overlapping second data subsets.

13. The computer-readable medium of claim 12, wherein the second dataset comprises an update to the first dataset.

14. The computer-readable medium of claim 12, wherein:
the second dataset comprises data from a second source different than a first source for the first dataset;
the instructions operable to analyze the second dataset comprise instructions operable to store a second interaction index, the second interaction index comprising a record for each identified second interaction from the plurality of second interactions, the record comprising one or more words representing the interaction and one or more words for each of the two or more entities associated with the interaction; and
the instructions operable to receive a query regarding a specific interaction for a specific entity comprise instructions operable to receive an identification of the first dataset or the second dataset;
the instructions further operable to determine whether one of the interactions for the identified dataset and for the specific entity match the specific interaction.

15. A system, comprising
a memory configured to store a plurality of datasets;
at least one computer interoperably coupled with the memory and configured to:
receive a first dataset comprising information about a first plurality of entities and comprising a plurality of non-overlapping first data subsets, each of the first data subsets having the same predetermined size;
store the first dataset in the memory;
analyze the first dataset to identify a plurality of first interactions in the first dataset, each identified first interaction associated with two or more entities from the first plurality of entities based on determining that information about the interaction and the two or more entities occurs in one of the non-overlapping first data subsets;
receive a query regarding a specific interaction for a specific entity;
determining whether one of the identified first interactions for the specific entity matches the specific interaction; and
provide information from one or more non-overlapping first data subsets that each comprise data about the specific interaction and the specific entity based on determining that at least one of the identified first interactions for the specific entity matches the specific interaction.

16. The system of claim 15, further configured to store, based on analyzing the first dataset to identify the plurality of first interactions in the first dataset, a first interaction index, the first interaction index comprising a record for each identified first interaction from the plurality of first interactions, the record comprising one or more words representing the interaction and one or more words for each of the two or more entities associated with the interaction.

17. The system of claim 16, wherein:
the first interaction index comprises an unambiguous interaction index;
storing the first interaction index comprises:
determining whether the words that represent the first interactions and words that represent the entities from the first plurality of entities are master terms in an alternate spelling index; and
storing a corresponding master term in the unambiguous first interaction index for the words that are determined not to be master terms in the alternate spelling index; and
determining whether one of the identified first interactions for the specific entity matches the specific interaction comprises:
determining whether the specific interaction and the specific entity are master term entries in the alternate spelling index; and
determining whether one of the identified first interactions for the specific entity or a corresponding master term entry for the specific entity matches the specific interaction or a corresponding master term entry for the specific interaction.

18. The system of claim 15, wherein the predetermined size comprises a sentence.

19. The system of claim 15, further configured to:
receive a second dataset comprising information about a second plurality of entities and comprising a plurality of non-overlapping second data subsets, each of the second data subsets having the same predetermined size as the first data subsets; and
analyze the second dataset according to a predetermined schedule identify a plurality of second interactions in the second dataset, each identified second interaction associated with two or more entities from the second plurality of entities based on determining that information about the interaction and the two or more entities occurs in one of the non-overlapping second data subsets.

20. The system of claim 19, wherein the second dataset comprises an update to the first dataset.

21. The system of claim 19, wherein:
the second dataset comprises data from a second source different than a first source for the first dataset;
analyzing the second dataset comprises storing a second interaction index, the second interaction index comprising a record for each identified second interaction from the plurality of second interactions, the record comprising one or more words representing the interaction and one or more words for each of the two or more entities associated with the interaction; and
receiving a query regarding a specific interaction for a specific entity comprises receiving an identification of the first dataset or the second dataset;
the method further comprising determining whether one of the interactions for the identified dataset and for the specific entity match the specific interaction.
